(19) United States
(12) Patent Application Publication
(10) Pub. No.: US 2022/0161762 A1
(43) Pub. Date: May 26, 2022

(54) SENSOR SYSTEM

(71) Applicant: KOITO MANUFACTURING CO., LTD., Tokyo (JP)

(72) Inventor: Hiroshi Inoue, Shizuoka (JP)

(73) Assignee: KOITO MANUFACTURING CO., LTD., Tokyo (JP)

(21) Appl. No.: 17/440,889

(22) PCT Filed: Mar. 9, 2020
(86) PCT No.: PCT/JP2020/009991

§ 371 Date: Sep. 20, 2021

(30) Foreign Application Priority Data
Mar. 20, 2019 (JP) 2019-052838

(51) Int. Cl. B60S 1/02; G01S 13/931; G01S 7/40; B60S 1/56; B60S 1/46; B60S 1/54; C09K 3/18

(52) U.S. Cl. CPC B60S 1/023; G01S 13/931; G01S 7/4043; B60S 1/56; G01S 2013/9324; B60S 1/54; C09K 3/18; G01S 2013/9323; B60S 1/46

(57) ABSTRACT

A sensor is configured to output a signal corresponding to information in an outside area of the vehicle. A defogging device is configured to supply at least one of water, a compound, hot air, charged particles, ultrasonic waves, and infrared radiations to at least a portion of a detection area of the sensor.

### FIELD

The presently disclosed subject matter relates to a sensor system adapted to be installed in a vehicle.

### BACKGROUND

In order to perform driving support of a vehicle, a sensor for detecting information in an outside area of the vehicle is mounted on a body of the vehicle. Patent Document 1 discloses a radar as such a sensor.

As used herein, the term “driving support” means control processing that at least partially performs at least one of driving operation (steering operation, acceleration, deceleration, etc.), monitoring of a driving environment, and backup of driving operation. That is, the term means not only the partial driving support such as braking function for collision avoidance and assisting function for lane-keeping, but also a full self-driving operation.

### CITATION LIST

### Patent Document

Patent Document 1: Japanese Patent Publication No. 2007-106199 A

### SUMMARY

### Technical Problem

It is demanded to suppress degradation in the information detecting capability of the sensor mounted on a vehicle.

### Solution to Problem

In order to meet the demand described above, an illustrative aspect of the presently disclosed subject matter provides a sensor system adapted to be installed in a vehicle, comprising:

a sensor configured to output a signal corresponding to information in an outside area of the vehicle; and

a defogging device configured to supply at least one of water, a compound, hot air, charged particles, ultrasonic waves, and infrared radiations to at least a portion of a detection area of the sensor.

The sensor may include at least one of a LiDAR (Light Detection and Ranging) sensor, a camera, a millimeter wave radar, and an ultrasonic sensor.

Fog is a phenomenon in which minute water droplets are floating in the air. The non-visible light, the millimeter wave, and the ultrasonic wave used by the sensor to detect the information are subjected to absorption by the water molecules constituting the water droplets. Accordingly, when the non-visible light, the millimeter wave, or the ultrasonic waves are emitted into a fogged atmosphere, there would be a case where reflected light or a reflected wave sufficient for detecting information is not available. When a camera is used as the sensor, there would be a case where the field of view of the camera is blurred so that desired image information is not available.

According to the configuration as described above, it is possible to form a fog-thinning environmental condition in a space including the detection area of the sensor. Accordingly, it is possible to suppress degradation in the information detecting capability of the sensor caused by the fog.

For example, the supplied water combines with minute water droplets floating in the air to form the fog. As the size and weight increase with the aggregation, the water droplets cannot float in the air and fall to the ground. As a result, the fog can be thinned or vanished.

When at least one of the compound, the charged fine particles, the ultrasonic waves, and the infrared radiations is supplied, the fine water droplets floating in the air to form the fog are promoted to aggregate with each other. As the size and weight increase with the aggregation, the water droplets cannot float in the air and fall to the ground. As a result, the fog can be thinned or vanished.

The compound may include at least one of sodium chloride, calcium chloride, and silver iodide.

The fog is formed by minute water droplets whose water vapor pressure reaches a saturation state. In a case where warm air is supplied, as the temperature of the road surface or the space to which the warm air is blown rises, the saturation vapor pressure also rises. Since the water vapor pressure of the minute water droplets does not reach the saturation state, it is impossible to form the fog at last. As a result, the fog can be thinned or vanished.

The sensor system may be configured to include a processor configured to activate the defogging device in accordance with the signal.

For example, when the processor determines that there is a significant deterioration in the quality of the signal (or the corresponding information) outputted from the sensor, the processor activates the defogging device. According to such a configuration, it is possible to automate the defogging operation for suppressing degradation in the information detecting capability pf the sensor.

The sensor system may be configured to include a processor configured to activate the defogging device in accordance with activation of a fog lamp.

When the fog lamp is turned on, the vehicle is likely to be in a fogged environment. Accordingly, by configurating the defogging device so as to be activated in conjunction with the activation of the fog lamp, it is possible to automate the defogging operation for suppressing the deterioration of the information detecting capability of the sensor.

### BRIEF DESCRIPTION OF DRAWINGS

FIG. 1 illustrates a configuration of a sensor system according to an embodiment.

FIG. 2 illustrates another exemplary configuration of the sensor system of FIG. 1.

### DESCRIPTION OF EMBODIMENTS

Examples of embodiments will be described below in detail with reference to the accompanying drawings. In each of the drawings used in the following descriptions, the scale is appropriately changed in order to make each of the members have a recognizable size.

In the accompanying drawings, an arrow F represents a forward direction of the illustrated structure. An arrow B represents a rearward direction of the illustrated structure. An arrow U represents an upward direction of the illustrated structure. An arrow D represents a downward direction of the illustrated structure.

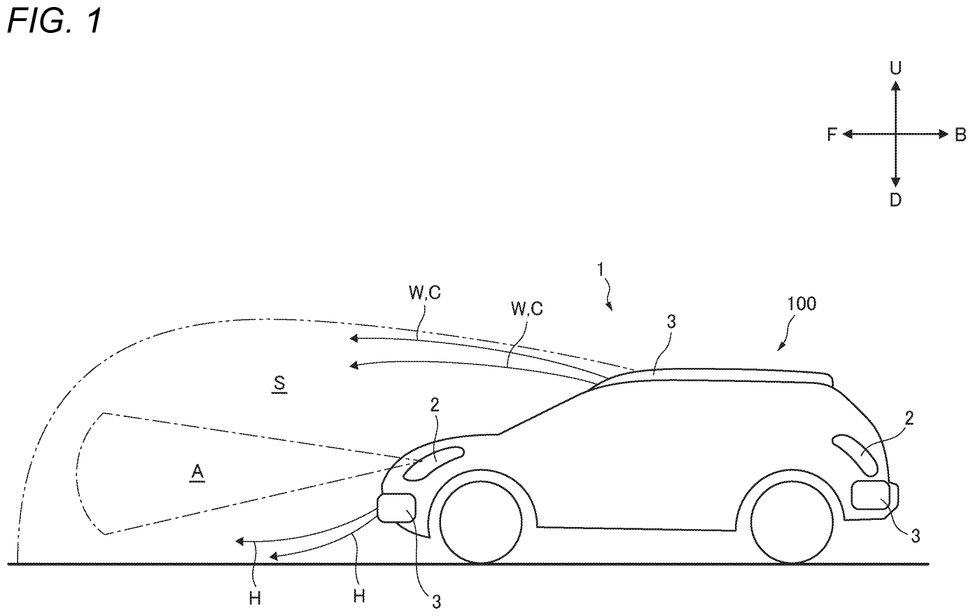

FIG. 1 illustrates a configuration of a sensor system 1 according to an embodiment. The sensor system 1 is installed in a vehicle 100. The shape of the vehicle body of the vehicle 100 is a mere example.

The sensor system 1 includes a sensor 2. The sensor 2 is mounted at an appropriate position in the vehicle 100 to detect information in an outside area of the vehicle 100.

The sensor 2 is, for example, a LiDAR sensor. The LiDAR sensor has a configuration for emitting non-visible light toward an outside area of the vehicle 100 as well as a configuration for detecting returned light as a result of the non-visible light being reflected by an object existing in the outside area. As required, the LiDAR sensor may include a scanning device that sweeps the non-visible light to change the light emitting direction (i.e., the detecting direction). The wavelength of the non-visible light is, for example, 905 nm.

The LiDAR sensor can detect a distance to an object associated with the returned light, for example, based on the time period from the time when the non-visible light is emitted in a certain direction to the time when the returned light is detected. Further, by accumulating such distance information in association with the detecting position, it is possible to detect information as to the shape of the object associated with the returned light. Additionally or alternatively, information as to an attribute such as the material of the object associated with the returned light can be detected based on the difference in waveforms between the emitted light and the returned light. The LiDAR sensor is configured to output a signal corresponding to the detected information.

The sensor 2 is, for example, a camera. The camera is a device for acquiring image information in the outside area of the vehicle 100. The image may include at least one of a still image and a video image. The camera is configured to output a signal corresponding to the acquired image information.

The sensor 2 is, for example, a millimeter wave radar. The millimeter wave radar has a configuration for transmitting a millimeter wave as well as a configuration for receiving a reflected wave as a result of the millimeter wave being reflected by an object existing in an outside area of the vehicle 100. The frequency of the millimeter wave is, for example, any of 24 GHz, 26 GHz, 76 GHz, and 79 GHz.

The millimeter wave radar can detect a distance to an object associated with the reflected wave, for example, based on the time period from the time when the millimeter wave is transmitted in a certain direction to the time when the reflected wave is received. In addition, by accumulating such distance data in association with the detecting position, it is possible to acquire information as to the shape of the object associated with the reflection wave. The millimeter wave radar is configured to output a signal corresponding to the detected information.

The sensor 2 is, for example, an ultrasonic sensor. The ultrasonic sensor has a configuration for transmitting ultrasonic waves (several tens of kHz to several GHz) as well as a configuration for receiving reflected waves as a result of the ultrasonic waves being reflected by an object existing in an outside area of the vehicle 100.

The ultrasonic sensor can detect a distance to an object associated with the reflected wave, for example, based on the time period from the time when the ultrasonic wave is transmitted in a certain direction to the time when the reflected wave is received. In addition, by accumulating such distance data in association with the detecting position, it is possible to acquire information as to the shape of the object associated with the reflection wave. The ultrasonic sensor is configured to output a signal corresponding to the detected information.

Fog is a phenomenon in which minute water droplets are floating in the air. The non-visible light, the millimeter wave, and the ultrasonic wave used by the sensor 2 are subjected to absorption by the water molecules constituting the water droplets. Accordingly, when the non-visible light, the millimeter wave, or the ultrasonic waves are emitted into a fogged atmosphere, there would be a case where reflected light or a reflected wave sufficient for detecting information is not available. When a camera is used as the sensor 2, there would be a case where the field of view of the camera is blurred so that desired image information is not available.

In order to cope with this problem, the sensor system 1 includes a defogging device 3. The defogging device 3 is a device configured to form a fog-thinning environmental condition in a space S including a detection area A from which information can be detected with the sensor 2.

The defogging device 3 may be mounted at an appropriate position in the vehicle 100 in accordance with the location of the detection area. A of the sensor 2. In the example illustrated in FIG. 1, the defogging device 3 is disposed on a ceiling portion of the vehicle 100.

The defogging device 3 is, for example, a device for spraying water W toward at least a portion of the detection area A of the sensor 2.

The sprayed water W is combined with minute water droplets floating in the air to form the fog. As the size and weight increase with the aggregation, the water droplets cannot float in the air and fall to the ground. As a result, the fog can be thinned or vanished.

The defogging device 3 is, for example, a device for spraying a compound C toward at least a portion of the detection area A of the sensor 2. Examples of the compound C include sodium chloride, calcium chloride, and silver iodide. The compound C may be mixed with the water W.

The sprayed compound C promotes the aggregation of minute water droplets floating in the air to form the fog. As the size and weight increase with the aggregation, the water droplets cannot float in the air and fall to the ground. As a result, the fog can be thinned or vanished.

In addition to or instead of the above compound, at least one of charged fine particles, ultrasonic waves, and infrared rays may be supplied toward at least a portion of the detection area A of the sensor 2 in order to promote the aggregation of fine water droplets forming the fog. However, in a case where the sensor 2 is an ultrasonic sensor, the defogging device 3 does not use ultrasonic waves in order to avoid interference. Similarly, in a case where the sensor 2 uses infrared light for detecting information, the defogging device 3 does not use infrared radiations in order to avoid interference.

In addition to or instead of the above configuration, the defogging device 3 may include a device for supplying warm air H toward at least a portion of the detection area A of the sensor 2. In the example illustrated in FIG. 1, the device is disposed at a front end portion of the vehicle 100.

The fog is formed by minute water droplets whose water vapor pressure reaches a saturation state. As the temperature of the road surface or the space to which the warm air H is blown rises, the saturation vapor pressure also rises. Since the water vapor pressure of the minute water droplets does not reach the saturation state, it is impossible to form the fog at last. As a result, the fog can be thinned or vanished.

According to each of the above techniques, it is possible to form a fog-thinning environmental condition in the space S including the detection area A of the sensor 2. The dashed chain lines in FIG. 1 indicate the interface between an ordinary atmosphere and the space S in which the environmental condition is controlled with the manner mentioned above. As a result, it is possible to suppress degradation in the information detecting capability of the sensor 2 caused by the fog.

At least one of the water W, the compound C, the warm air H, the charged particles, the ultrasonic waves, and the infrared radiations may be continuously supplied or intermittently supplied by the defogging device 3.

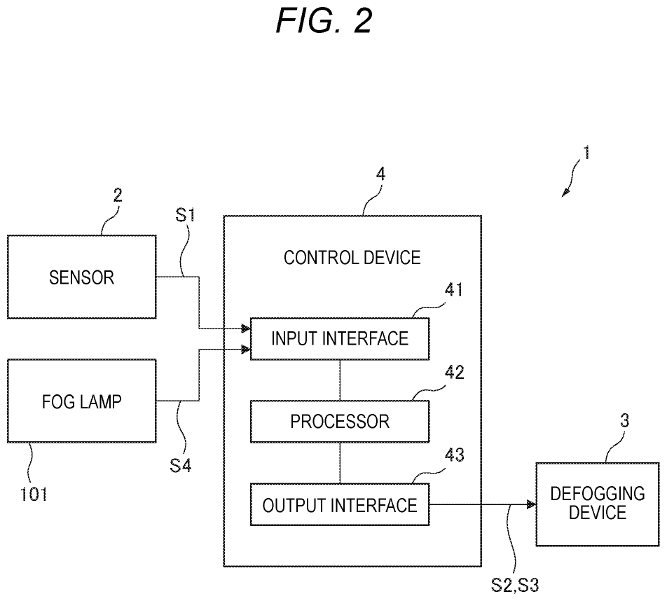

As illustrated in FIG. 2, the sensor system 1 may include a control device 4. The control device 4 includes an input interface 41, a processor 42, and an output interface 43. The control device 4 may be mounted at an appropriate position in the vehicle 100.

As described above, the sensor 2 outputs a sensor signal S1 corresponding to the detected information. The input interface 41 receives the sensor signal S1 outputted from the sensor 2. As required, the input interface 41 may include a signal processing circuit that converts the sensor signal S1 into a form suitable for processing performed by the processor 42.

The processor 42 is configured to control the operation of the defogging device 3 based on the sensor signal S1 received from the sensor 2. Specifically, the processor 42 determines whether significant degradation is observed in the quality of the sensor signal S1 (or the corresponding information). “Significant deterioration” means a state in which a desired signal level or signal waveform is not available. The processor 42 generates a control signal S2 for activating the defogging device 3 when a significant deterioration is observed in the quality of the sensor signal S1.

The processor 42 outputs a control signal S2 from the output interface 43. When receiving the control signal S2, the defogging device 3 executes the above-described defogging operation. As required, the output interface 43 may include a signal processing circuit that converts the control signal S2 into a form suitable for processing performed by the defogging device 3.

According to such a configuration, it is possible to automate the defogging operation for suppressing degradation in the information detecting capability of the sensor 2.

The processor 42 continues to monitor the quality of the sensor signal S1 received by the input interface 41. When recovery of the quality of the sensor signal S1 is observed by virtue of the operation of the defogging device 3, the processor 42 generates a control signal S3 for stopping the operation of the defogging device 3, and outputs the same from the output interface 43. As required, the output interface 43 may include a signal processing circuit that converts the control signal S3 into a form suitable for processing performed by the defogging device 3. When receiving the control signal S3, the defogging device 3 stops the defogging operation.

Additionally or alternatively, the input interface 41 may receive a lighting signal S4 indicating that a fog lamp 101 mounted on the vehicle 100 is turned on. In this case, the input interface 41 may include, as required, a signal processing circuit that converts the lighting signal S4 into a form suitable for the processing performed by the processor 42.

The processor 42 may be configured to control the operation of the defogging device 3 in conjunction with the turning-on/off of the fog lamp 101. Specifically, when the input interface 41 receives the lighting signal S4, the processor 42 generates a control signal S2 for activating the defogging device 3, and outputs the same from the output interface 43. When receiving the control signal S2, the defogging device 3 executes the above-described defogging operation.

When the fog lamp 101 is turned on, the vehicle 100 is likely to be in a fogged environment. Accordingly, by configurating the defogging device 3 so as to be activated in conjunction with the activation of the fog lamp 101, it is possible to automate the defogging operation for suppressing the deterioration of the information detecting capability of the sensor 2.

When the fog lamp 101 is turned off, the lighting signal S4 disappears. In this case, the processor 42 generates a control signal S3 for stopping the operation of the defogging device 3, and outputs the same from the output interface 43. When receiving the control signal S3, the defogging device 3 stops the defogging operation.

The processor 42 capable of performing the above-described processing may be provided as a general-purpose microprocessor operating in cooperation with a general-purpose memory, or may be provided as part of a dedicated integrated circuit device. Examples of the general-purpose microprocessor include a CPU, an MPU, and a GPU.

Examples of the general-purpose memory include a RAM and a ROM. Examples of the dedicated integrated circuit element include a microcontroller, an ASIC, and an FPGA.

The above embodiments are mere examples for facilitating understanding of the gist of the presently disclosed subject matter. The configuration according to the above embodiments can be appropriately modified or improved without departing from the gist of the presently disclosed subject matter.

There has been described the defogging operation for suppressing degradation in the detecting capability of the sensor 2 in connection with the information of the area located at least ahead of the vehicle 100. As illustrated in the drawing, the sensor 2 may be disposed so as to detect information in an area located at least behind the vehicle 100. In this case, although not illustrated, the defogging device 3 is configured to supply at least one of water, a compound, warm air, charged fine particles, ultrasonic waves, and infrared rays toward at least a portion of the detection area of the sensor 2 located at least behind the vehicle 100.

The present application is based on Japanese Patent Application No. 2019-052838 filed on Mar. 20, 2019, the entire contents of which are incorporated herein by reference.

1. A sensor system adapted to be installed in a vehicle, comprising:
a sensor configured to output a signal corresponding to information in an outside area of the vehicle; and
a defogging device configured to supply at least one of water, a compound, hot air, charged particles, ultrasonic waves, and infrared radiations to at least a portion of a detection area of the sensor.

2. The sensor system according to claim 1,
wherein the compound includes at least one of sodium chloride, calcium chloride, and silver iodide.

3. The sensor system according to claim 1, further comprising:
a processor configured to activate the defogging device in accordance with the signal.

4. The sensor system according to claim 1, further comprising:
a processor configured to activate the defogging device in accordance with activation of a fog lamp.

5. The sensor system according to claim 1,
wherein the sensor includes at least one of a LiDAR sensor, a camera, a millimeter wave radar, and an ultrasonic sensor.
